(19) United States
(12) Patent Application Publication
(10) Pub. No.: US 2026/0359417 A1
(43) Pub. Date: Nov. 12, 2026

(54) Virtual Keypad for Reconfigured Code Entry

(71) Applicant: Comcast Cable Communications, LLC, Philadelphia, PA (US)

(72) Inventors: Somesh Verma, Kancheepuram (IN); Prabhuram Natarajan, Chennai (IN)

(21) Appl. No.: 19/203,843

(22) Filed: May 9, 2025

(51) Int. Cl. G06F 21/36; G06F 3/02; G06F 3/04886; G06F 21/45; G06F 21/83

(52) U.S. Cl. CPC G06F 21/36; G06F 3/0219; G06F 3/04886; G06F 21/45; G06F 21/83

(57) ABSTRACT

Systems, apparatuses, and methods are described for displaying a circular keypad. The keypad may comprise input keys and null keys (e.g., blank spaces). The keypad layout may be reconfigured after each user to prevent unauthorized access and pattern recognition. Null keys may change in quantity, size, and/or position after each reconfiguration. The circular keypad may be used for various user applications such as ATM login, credit card authentication, door code input, safe deposit box access, etc.

### BACKGROUND

Users may enter personal identification data to access secured information or products, such as entering a personal identification number (PIN) to access an ATM or other machine. A PIN may be entered by touching keys displayed on a display screen. However, a display screen may retain residual information, such as fingerprints or smudges, that can show where a user touched the screen. This residual information may allow a bad actor see where a previous user touched the screen and deduce that previous user's PIN or other personal information.

### SUMMARY

The following summary presents a simplified summary of certain features. The summary is not an extensive overview and is not intended to identify key or critical elements.

Systems, apparatuses, and methods are described for displaying a keypad. The keypad may be a software-based virtual keypad. The keys may, for example, be in a circular configuration, with each of a plurality of selectable input keys corresponding to separate sectors of the circular configuration. The keypad may be output on a touch screen or other type of display device. The keypad may comprise non-selectable null keys between input keys, and the input keys may be arranged (e.g., clockwise, counterclockwise) in a numeric or other order. After input of a code via the keypad, the keypad may be reconfigured to have a different configuration of input keys and null keys. The user may also or alternatively request that a keypad be reconfigured. Reconfiguration may comprise rotationally shifting some or all input keys. Reconfiguration may also or alternatively comprise adding, deleting, moving, and/or changing size of one or more null keys. Reconfiguration may also or alternatively comprise changing from a clockwise ordering of input keys to a counterclockwise ordering (or vice versa) and/or moving a keypad from one location on a display screen to another location on the display screen. Other types of reconfiguration are described herein. Reconfiguration of a keypad makes it more difficult for a bad actor to steal a user's PIN or other code between entries. Keypads such as those described herein may be used for various user applications in areas such as data security, physical access and security, device authentication, payment verification, etc.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIGS. 3A, 3B, 3C, and 3D show example circular configurations of keys.

FIGS. 4A, 4B, 4C, 4D, 4E, 4F, 4G, 4H, and 4I show example user interfaces for receiving user input regarding authorization.

FIGS. 5A, 5B, 5C, and 5D show example user interfaces for receiving user input regarding authorization.

FIGS. 6A, 6B, 6C, and 6D show example user interfaces for receiving user input regarding authorization.

FIGS. 7A, 7B, and 7C show example user interfaces for requesting reconfiguration of a keypad on a display device.

FIG. 8 shows example dimensions of a circular configuration of keys.

FIGS. 9A, 9B, 9C, and 9D show example user interfaces for receiving user input regarding authorization.

FIGS. 10A and 10B show example user interfaces for receiving user input regarding authorization.

FIGS. 11A-11C are a sequence diagram showing an example method for receiving input via a user interface comprising a keypad.

FIGS. 12A-12B are a flow chart showing an example method for reconfiguring a keypad.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

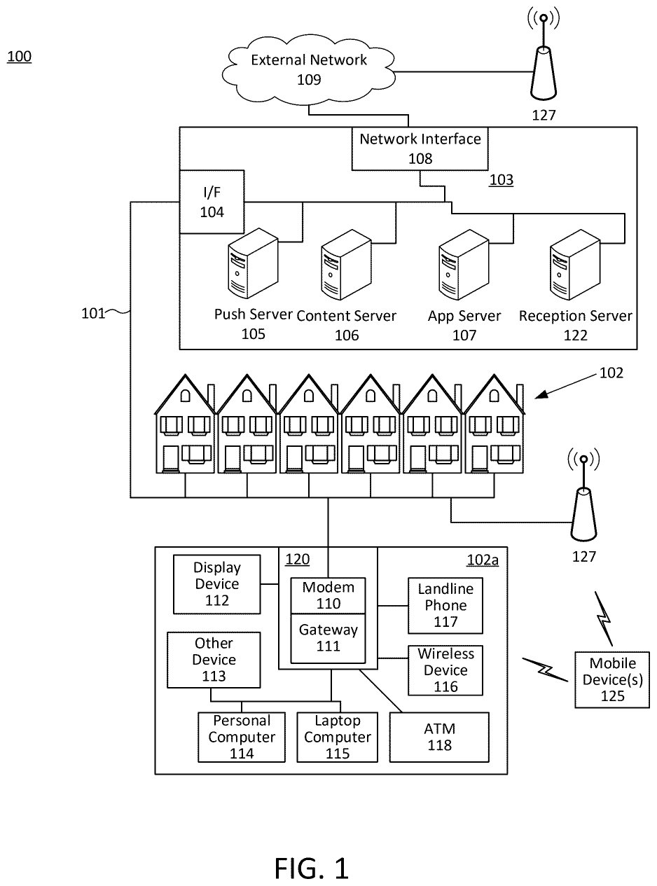

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and 122, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as additional push, content, and/or application servers, and/or other types of servers. Although shown separately, the push server 105, the content server 106, the application server 107, a reception server 122 configured to receive data (e.g., PINs or other codes) corresponding to input from computing devices in premises 102a received via user interfaces having keypads such as those described herein, and/or other server(s) may be combined. The servers 105, 106, 107, and 122, and/or other servers, may be computing devices and may comprise memory storing data and also storing computer executable instructions that, when executed by one or more processors, cause the server(s) to perform steps described herein. Also or alternatively, one or more of servers 105, 106, 107, and 122, and/or other servers, may be part of the external network 109 and may be configured to communicate (e.g., via the local office 103) with computing devices located in or otherwise associated with one or more premises 102.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g., Voice over Internet Protocol—VoIP phones), and any other desired devices. One or more of the devices shown in the premises 102a may be configured to show, on a display, a UI with a keypad such as is described herein and/or to communicate with a computing device (e.g., the server 122 and/or a server in local office or in network 109) to provide input received via that UI. For example, example premises 102a may comprise an ATM 118 that may be configured to show, on a display, a UI with a keypad such as is described herein and/or to communicate with a computing device (e.g., the server 122 and/or a server in local office or in network 109) to provide input received via that UI. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on-or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

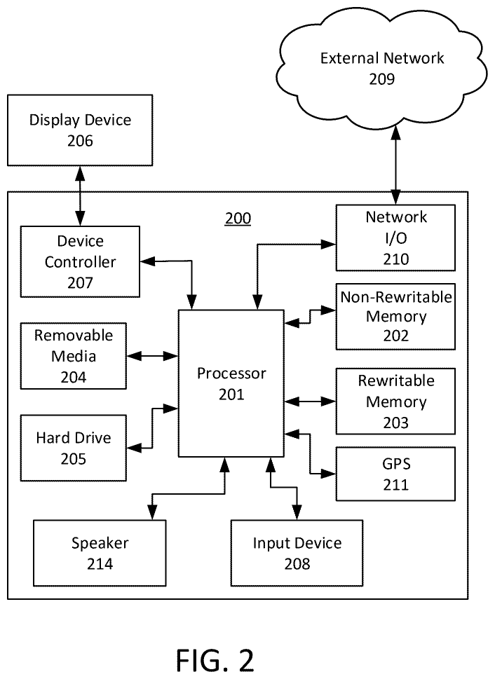

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices associated with the external network 109) and any other computing devices discussed herein. The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

As described in more detail below, a computing device may output a user interface (UI) on a display, which UI may comprise a keypad that comprises a plurality of selectable input keys, e.g., images representing programmable software buttons that can function as input keys. An input key may be a region of a display that a user may select by providing, in that region, an indication of selection. An indication of selection may, for example, comprise touching in that region (e.g., if the display is a touch screen), clicking a mouse and/or providing other input while a cursor is positioned in that region, etc. Selection of an input key may cause generation and/or sending of data that corresponds to information that has been mapped to and/or that corresponds to that input key. That data may be generated by and transmitted to other parts of a computing device that comprises a display on which the selected key was output. Also or alternatively, that data may be generated by the display (or by a computing device that comprises the display) and transmitted to another computing device. For example, a user may select keys of a keypad to input a personal identification number (PIN) or other type of code. Data from the user selection of keys may be evaluated (e.g., checked to make sure a correct code was input) and/or acted upon (e.g., one or more communications may be sent and/or one or more other operations may be performed based on the data) by a computing device that comprises a display on which the selected keys were output. Also or alternatively, data from the user selection of keys on a display of a first computing device may be sent to a second computing device for evaluation and/or to be acted upon.

Input keys of a keypad may be selected to input a PIN or other code that comprises a series of one or more code elements that are members of a code element set from which codes may be formed. In the examples below, codes comprise a series of digits (e.g., 78543) and/or repetitions of digits (e.g., 22222 or 22233). In such examples, code elements may be the digits of that code and the code element set may be a set of digits from 0 through 9 (e.g., {0, 1, 2, 3, 4, 5, 6, 7, 8, 9}). In other examples according to this disclosure, code elements may comprise letters and/or other characters, symbols, and/or combinations of digits, characters, and/or symbols. For example, a code may comprise one or more code elements that are members of a code element set of letters (e.g., {A, B, C, D, E, F, G, . . . }), of symbols (e.g., {#, &, *, $, . . . }), of non-western language characters (e.g., Chinese, Japanese, Arabic, Russian, Korean, or other language characters), or of a combination of digits, letters, symbols, and/or non-western language characters (e.g., {1, 2, 3, . . . A, B, C, . . . #, &, *, . . . <non-western char.>, <non-western char.>, <non-western char.>, . . . }). Members of a code element set need not be single digits, letters, symbols, or characters. Each member of a code element set (or each of one or more but less than all members of a code element set) may comprise multiple digits, multiple letters (e.g., a word), a combination of letters and numbers (e.g., a hexadecimal value), and/or any other combination of digits, letters, symbols, and/or non-western language characters. Members of a code element set may have an order that is by convention implied and/or understood (e.g., ascending numerical order, descending numerical order, alphabetical, reverse alphabetical) and/or a defined order.

As indicated above, selection of an input key may cause generation and/or sending of data that corresponds to information that has been mapped to and/or that corresponds to that input key. An input key may comprise, in the display region of that input key, a visual representation of the information that has been mapped to that input key. For a keypad used to input a PIN or other code, that visual representation may be a representation of a member of a code element set (e.g., one of digits 0 through 9 in the examples below).

Keypads may also comprise one or more null keys. A null key may comprise a region of a keypad that has the appearance of an input key (or an appearance similar to the appearance of an input key), but that does not correspond to (and is not mapped to) a member of a code input set. A null key may not be mapped to any information, and/or may not be selectable. A null key may not be an actual key. For example, touching or otherwise indicating a selection in a null key region of a display may not result in any input (e.g., no generation or transmission of data). A null key, or multiple null keys, may be spacers/separators inserted between input keys of a keypad. A null key may be blank, or a null key may include a visual representation (e.g., a picture, symbol, word, or other indicia).

Features herein may provide a more secure PIN or other code entry for users and allow users to access their accounts, content, and/or belongings and prevent bad actors from stealing the user's code. A keypad may comprise a plurality of input keys and one or more null keys in circular configuration. Each of the input and null keys may be assigned to/located in a separate sector of a circle. A keypad may be reconfigured between input sessions (e.g., after a first user inputs a code and before a second user inputs a code), on request, and/or at other times. Reconfiguring a keypad with a circular configuration may comprise one or more of the following: rotationally shifting all input keys; rotationally shifting some input keys but not others; adding, deleting, moving, and/or changing size of one or more null keys; changing from input keys following an order in a clockwise (CW) direction to following the order in a counterclockwise (CCW) direction; and/or moving a keypad to a different portion of a display. For example, input keys in a first order in the clockwise (CW) direction may be a set of digits from 0 through 9 with null keys interspersed, where the input keys are in ascending numerical order and the null keys are ignored for purposes of determining key ordering (e.g., {0, 1, 2, null, 3, null, null, 4, 5, 6, 7, null, 8, 9}). Changing from the input keys following an order in the clockwise direction to the counterclockwise direction could be equivalent to reversing the numerical order of the set of digits (e.g., {9, 8, null, 7, 6, 5, 4, null, null, 3, null, 2, 1, 0}). Ascending numerical order in CCW direction may be descending order in CW direction. Also or alternatively, a reconfiguration may comprise scrambling. Some or all of the input keys may be in a different relative order and/or may be adjacent to different keys, for example, if the reconfiguration comprises scrambling (e.g., scrambling from {9, 8, null, 7, 6, 5, 4, null, null, 3, null, 2, 1, 0} to {8, 4, null, 0, null, 2, 7, 3, null, null, 9, 1, 5, null, 6}).

Reconfiguration of a keypad may increase the difficulty for a bad actor to acquire a user's code from smudges or latent heat signature. Moreover, by reconfiguring without scrambling, the user may spend less time searching for each input key and the circular reconfiguration may be less confusing.

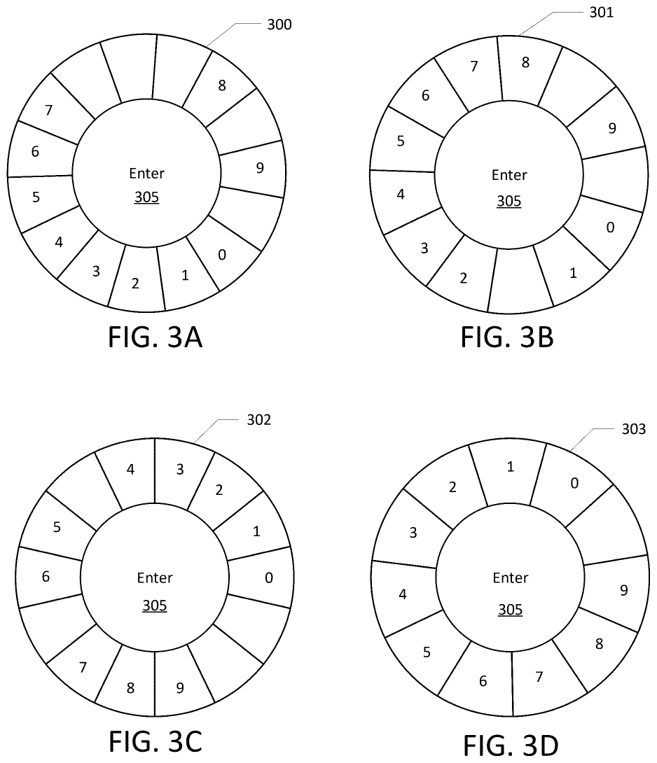

FIGS. 3A-3D show example circular configurations of sectors. Each circular configuration of sectors may comprise input keys and one or more null keys. The input keys may indicate the set of digits 0 through 9 that a user may select to enter their code. Each circular configuration may be referred to as a keypad for user input, and each keypad may allow the user to input a code comprising one or more digits (e.g., 5 digits). The input keys may be in a clockwise or a counterclockwise configuration to avoid user confusion while entering the code. Each circular configuration may have an enter button 305, located centrally. The example circular configurations in FIGS. 3A-3D may have the same radius. Each input key may be mapped to a corresponding code element, of a set of corresponding code elements, and may be selectable to generate an input of its corresponding code element as a part of the code and wherein each null key, of the one or more null keys, may not be selectable to generate an input of a part of the code. The example circular configurations may show different configurations of sectors. Reconfiguring a circular configuration may include changing a quantity of null keys, changing the rotational order of the input keys (e.g., clockwise, counterclockwise), changing the positions of null keys and/or input keys, changing the angular widths of null keys and/or input keys, and/or changing the circular configuration to a grid configuration, etc.

FIG. 3A shows an example circular configuration 300 comprising a plurality of input keys and one or more null keys. The center of the example circular configuration 300 may contain the enter button 305 for submitting a code entered using the input keys. The input keys may be in a different sector compared to the input keys of example circular configuration 301, 302, 303, and/or other circular configurations. Example circular configuration 300 may have a first input key in a first sector (e.g., an outer sector bounded by a circumference of the circular configuration 300). For example, example circular configuration 300 may have an input key “8” in the first sector.

FIG. 3B shows an example circular configuration 301 comprising a different configuration of the plurality of input keys and one or more null keys. The input keys may be in a different sector compared to the input keys of example circular configuration 300, 302, 303, and/or other circular configurations. Example circular configuration 301 may have the first input key in a second sector (e.g., an outer sector bounded by a circumference of the circular configuration 301). For example, example circular configuration 301 may have the input key “8” in the second sector. The quantity of null keys in example circular configuration 301 may be different from the quantity of null keys in example circular configuration 300 (and/or in other circular configurations). In example circular configuration 301, the adjacent input keys separated by one or more null keys may differ from the adjacent input keys separated by one or more null keys in example circular configuration 300. The input keys of example circular configuration 301 may also be in a different rotational order than example circular configurations 300 (e.g., clockwise or counterclockwise). The center of the example circular configuration 301 may contain the enter button 305.

FIG. 3C shows an example circular configuration 302 comprising a different quantity of null keys as compared to example circular configurations 300 and 301. The input keys and the null keys may also be in different sectors as compared to the input keys and null keys of example circular configurations 300, 301, and 303 (and/or other circular configurations). Example circular configuration 302 may have the first input key in a third sector (e.g., an outer sector bounded by a circumference of the circular configuration 302). For example, example circular configuration 302 may have the input key “8” in the third sector. The input keys of example circular configuration 302 may also be in a different rotational order than example circular configurations 300 and 301 (e.g., clockwise or counterclockwise). The center of the example circular configuration 302 may contain the enter button 305.

FIG. 3D shows an example circular configuration 303 comprising a different quantity of null keys as compared to example circular configurations 300, 301, and 302. The input keys and the null keys may also be in different sectors as compared to the input keys and null keys of example circular configurations 300, 301, and 302 (and/or other circular configurations). Example circular configuration 303 may have the first input key in a fourth sector (e.g., an outer sector bounded by a circumference of the circular configuration 303). For example, example circular configuration 303 may have the input key “8” in the fourth sector. The input keys of example circular configuration 303 may also be in a different rotational order than example circular configurations 300 and 301 (e.g., clockwise or counterclockwise). The center of the example circular configuration 303 may contain the enter button 305.

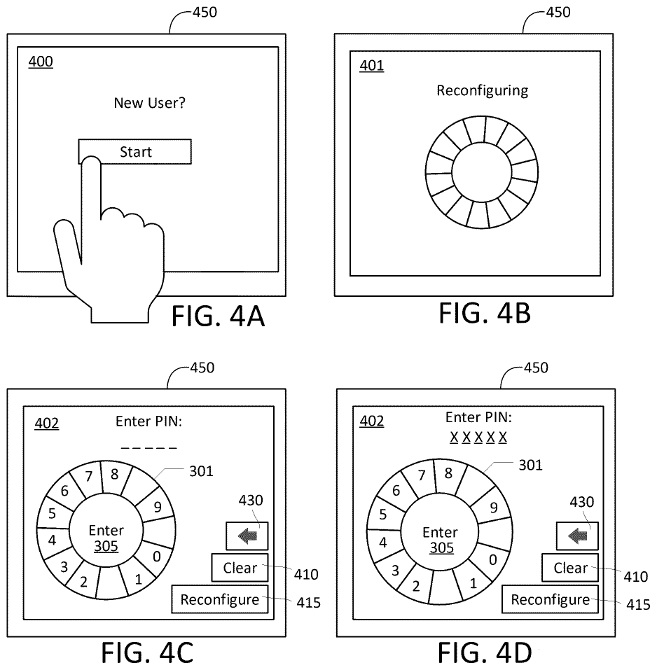

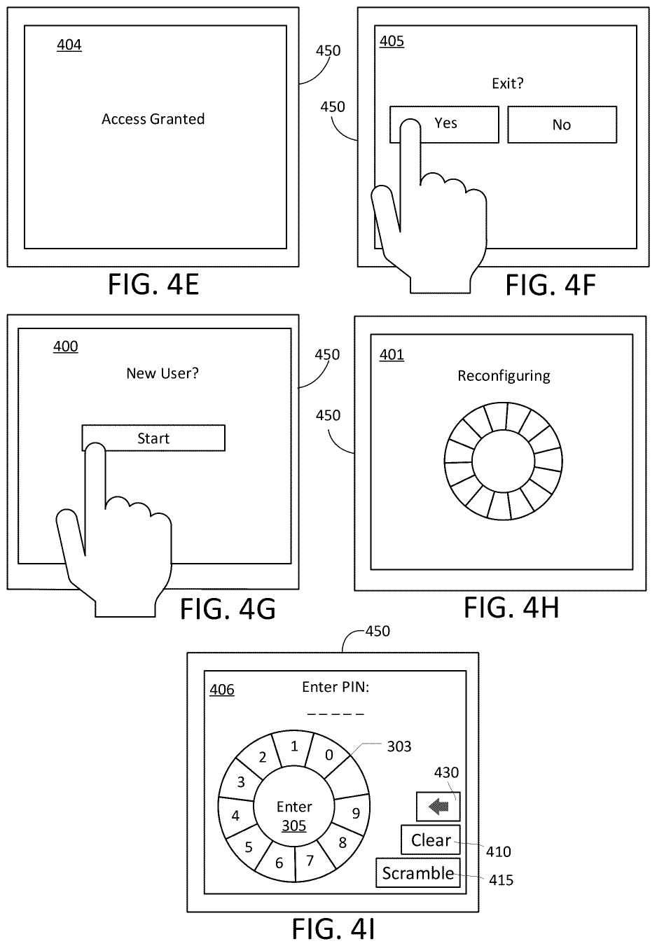

FIGS. 4A-4I show example user interfaces for receiving user input regarding authorization. For example, the example user interfaces of FIGS. 4A-4I may allow a user to input a code for accessing an ATM, using a credit card, entry to a safe deposit box, gate or door entry, etc. The user interfaces of FIGS. 4A-4I may be output to the user of a display device 450. The display device 450 may comprise a touch screen and may comprise, or be comprised by, a computing device.

As shown in FIG. 4A, an interface 400 may be output via the display device 450. The interface 400 may prompt the user to start an authorization, login, and/or other process for which a code may be required. A user may provide input selecting one of the options of interface 400, and/or of other interfaces described below, by selecting a box associated with an option (e.g., by manipulating a remote control and pressing an enter key, by selecting with a mouse, by touching a touch-screen) or by selecting boxes associated with multiple options, and by then selecting an “OK” button in the interface.

By selecting a start button, interface 401 of FIG. 4B may be output via the display device 450. The interface 401 may display a message indicating that the keypad is being reconfigured.

As shown in FIG. 4C, the interface 402 may be output via the display device 450 to prompt the user for input of their code. The interface 402 may comprise a first circular configuration of sectors, for example, example circular configuration 301 comprising input keys and null keys. By selecting one or more of the input keys, the user may provide input indicating their authorization code. By selecting a backspace button 430, the user may remove (e.g., unselect) the last digit (or other type of code element) selected. By selecting a clear button 410, the user may remove all entered code elements and begin selecting input keys again. By selecting a reconfigure button 415, the user may request a second circular configuration of sectors comprising input keys and null keys.

FIG. 4D shows the interface 402 that may be presented to the user via the display device 450 to prompt the user for input indicating whether the user has entered the code for authentication. By selecting enter button 305, the user may provide input indicating that the user desires that the code be evaluated.

FIG. 4E shows an interface 404 that may be presented to the user via the display device 450 to alert the user that the code is evaluated and access is authorized. FIG. 4F shows an interface 405 that may be presented to the user via the display device 450 to prompt the user for input indicating whether the user would like to exit the application or stay. By selecting a yes button, the user may provide input indicating that the user may desire to leave the application and/or device. By selecting a no button, the user may provide input indicating the user may desire to remain authorized on the platform and continue using the display device 450.

FIG. 4G shows the interface 400 may be output via the display device 450. The interface 400 may prompt a second user to start the authorization or login process, for example, if the first user selected to leave the application and/or device.

By selecting the start button, interface 401 of FIG. 4H may be output via the display device 450. The interface 401 may display the message indicating that the keypad is being reconfigured.

As shown in FIG. 4I, interface 406 may be output via the display device 450 to prompt the second user for input of their code. The interface 406 may comprise a second circular configuration of sectors, for example, example circular configuration 303 comprising a different configuration of input keys and null keys as compared to the example circular configuration 301. The example circular configuration of interface 406 may have the same radius as the example circular configuration of interface 402 for ease of use. By selecting one or more of the input keys of the interface 406, the second user may provide input indicating their code for authorization. By selecting the backspace button 430, the second user may remove the last code element selected. By selecting the clear button 410, the second user may remove all entered code elements and begin selecting input keys again. By selecting the reconfigure button 415, the second user may request a third circular configuration of sectors comprising a third configuration of input keys and null keys.

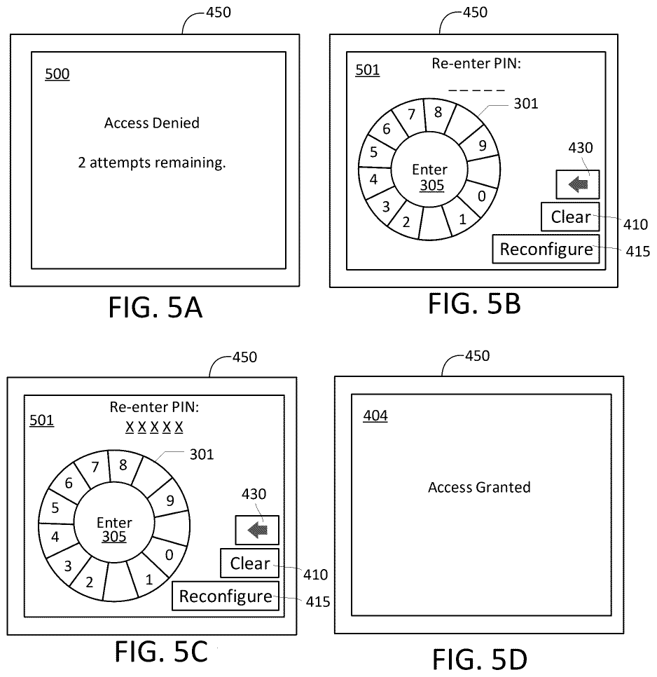

FIGS. 5A-5D show an example sequence of a user re-entering a code that was incorrectly input on the display device. The user interfaces of FIGS. 5A-5D may be output to the user of the display device 450.

FIG. 5A shows an interface 500 that may be output via the display device 450. The interface 500 may alert the user that the code was incorrectly input on the display device 450 and access is denied. The interface 500 may alert the user of a number of attempts remaining to re-enter the code.

FIG. 5B shows an interface 501 may be output via the display device 450 to prompt the user for re-entry of the code. The interface 501 may comprise a circular configuration of sectors, for example, example circular configuration 301 comprising input keys and null keys. By selecting one or more of the input keys, the user may provide input correctly indicating their code for authorization. By selecting the backspace button 430, the user may remove the last code element selected. By selecting the clear button 410, the user may remove all entered code elements and begin selecting input keys again. By selecting the reconfigure button 415, the user may request a different circular configuration of sectors comprising input keys and null keys.

FIG. 5C shows the interface 501 that may be presented to the user via the display device 450 to prompt the user for input indicating whether the user has re-entered the code for authentication. By selecting enter button 305, the user may provide input indicating that the user desires that the code is evaluated. FIG. 5D shows the interface 404 that may be presented to the user via the display device 450 to alert the user that the code is evaluated and access is authorized.

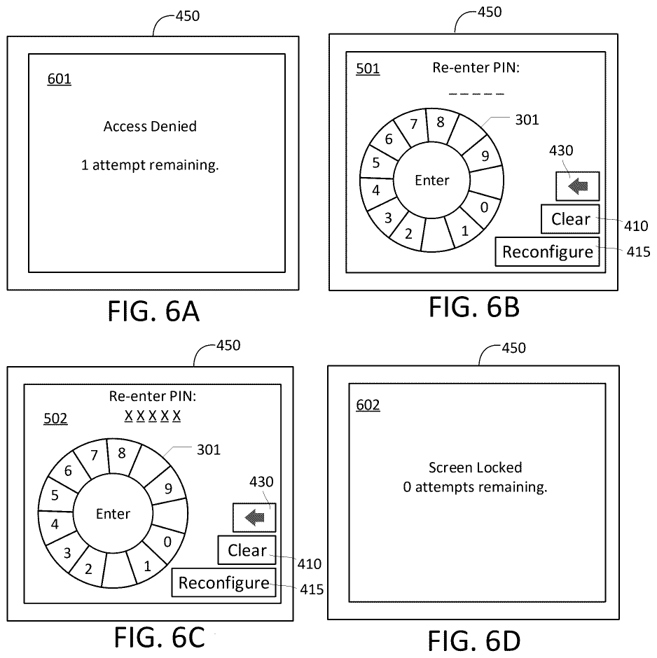

FIGS. 6A-6D show an example sequence of a user re-entering a code that was incorrectly input at least twice on the display device. The user interfaces of FIGS. 6A-6D may be output to the user of the display device 450.

FIG. 6A shows an interface 600 may be output via the display device 450. The interface 600 may alert the user that the code was incorrectly input on the display device 450 and access is denied. The interface 600 may alert the user of a number of attempts remaining to re-enter the code.

FIG. 6B shows the interface 501 that may be output via the display device 450 to prompt the user for re-entry of the code. The interface 501 may comprise a circular configuration of sectors, for example, example circular configuration 301 comprising input keys and null keys. By selecting one or more of the input keys, the user may provide input indicating their code. By selecting the backspace button 430, the user may remove the last code element selected. By selecting the clear button 410, the user may remove all entered code elements and begin selecting input keys again. By selecting the reconfigure button 415, the user may request a second circular configuration of sectors comprising input keys and null keys.

FIG. 6C shows the interface 501 that may be presented to the user via the display device 450 to prompt the user for input indicating whether the user has re-entered the code for authentication. By selecting enter button 305, the user may provide input indicating that the user desires that the code is evaluated.

FIG. 6D shows the interface 602 that may be presented to the user via the display device 450 to alert the user that the code entered was incorrect. The interface 602 may alert the user that the display device 450 has been locked and further attempts may not be permitted.

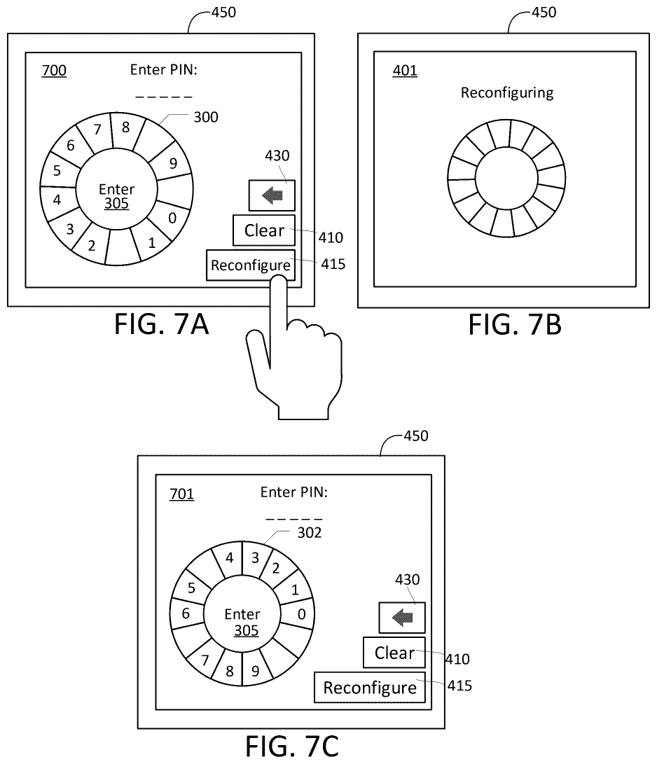

FIGS. 7A-7C show example user interfaces for a user to request that a keypad (e.g., a keypad with a circular configuration) be reconfigured on a display device. The user interfaces of FIGS. 7A-7C may be output to the user of the display device 450.

FIG. 7A shows the interface 700 that may be presented to the user via the display device 450 to prompt the user for input of the code and the user selecting the reconfigure button 415 requesting a reconfiguration of a keypad (e.g., a reconfiguration of sector assignments for input keys and null keys). The interface 700 may comprise a circular configuration of sectors, for example, example circular configuration 300 comprising input keys and null keys, as well as a backspace button 430, a clear button 410, and an enter button 305 having the functions previously described.

By selecting the reconfigure button 415, interface 401 of FIG. 7B may be output via the display device 450. The interface 401 may display the message indicating that the keypad is being reconfigured.

FIG. 7C shows an interface 701 that may be presented to the user via the display device 450 to prompt the user for input of the code. The interface 701 may comprise a second circular configuration of sectors. Although the interface 701 in the example of FIG. 7C comprises the circular configuration 302, a reconfigured keypad may comprise any of numerous other circular configurations that comprise input keys and null keys. Moreover, and regardless of whether reconfiguration is requested by a user or performed in response to other action (e.g., a new user pushing a start key, a user exiting the interface or corresponding application, incorrect entry of a code, etc.), a reconfigured keypad may comprise one or more of multiple types of reconfigurations.

For example, a reconfigured keypad may comprise one or more input keys that have been rotationally shifted. A rotationally-shifted input key in a reconfigured keypad may have a different angular position, relative to a reference, as compared to a position of that same input key prior to reconfiguration. For example, example circular configuration 303 of FIG. 3D may have the input key “1” in the first angular position relative to the reference (e.g., a 12 o'clock position at top of circle). Example circular configuration 302 of FIG. 3C may have the input key “1” in a different angular position relative to the reference, for example, after the keypad is reconfigured.

Also or alternatively, a reconfigured keypad may comprise a change in one or more null keys. This may, for example, comprise one or more changes in quantity, size and/or location of one or more null keys. The reconfigured keypad may comprise a change in the quantity of null keys as compared to the quantity of null keys prior to reconfiguration. For example, FIG. 7A shows interface 700 with example circular configuration 300. Example circular configuration 300 may have 3 null keys. After reconfiguration, FIG. 7C shows interface 701 with example configuration 302. Example configuration 302 may have 4 null keys. The reconfigured keypad may comprise a change in size of one or more null keys. For example, FIG. 4D shows interface 402 with example circular configuration 301 that may have 3 null keys and 10 input keys. After reconfiguration, FIG. 4I shows interface 406 with example circular configuration 303 that may have one null key and 10 input keys. Each circular configuration may have the same radius, and changing a quantity of keys may cause a change in angular widths of keys. For example, the lower quantity of keys in example circular configuration 303 may have different angular widths as compared to the greater quantity of keys in example circular configuration 301. The reconfigured keypad may comprise a change in location of one or more null keys. In FIG. 7A, one or more input keys of example circular configuration 300 may be separated at least one null key. For example, input keys “8” and “9” are separated by one null key on interface 700 in example circular configuration 300. After the keypad is reconfigured, the input keys “8” and “9” may be adjacent in the example circular configuration 302 of FIG. 7C.

Also or alternatively, a reconfigured keypad may comprise a reordering of input keys. The input keys may have a different rotational order (e.g., may follow a particular order in a clockwise or counterclockwise direction) after reconfiguration. For example, in FIG. 7A, the input keys of example circular configuration 300 may follow an order (ascending numerical order in this example) in a clockwise direction. After reconfiguration, the input keys in the example circular configuration 302 of FIG. 7C may follow that order in a counterclockwise direction.

Also or alternatively, a reconfigured keypad may comprise one or more changes in one or more relative positions of one or more input keys. Some adjacent input keys may be separated by one or more null keys after reconfiguration. Also or alternatively, some input keys separated by one or more null keys may be adjacent after reconfiguration. For example, in FIG. 7A, one or more input keys of example circular configuration 300 that are adjacent may be separated by at least one null key after reconfiguration in example circular configuration 302. For example, input keys “4” and “5” are adjacent on interface 700 in example circular configuration 300. After the keypad is reconfigured, the input keys “4” and “5” are separated by one null key in the example circular configuration 302 of FIG. 7C.

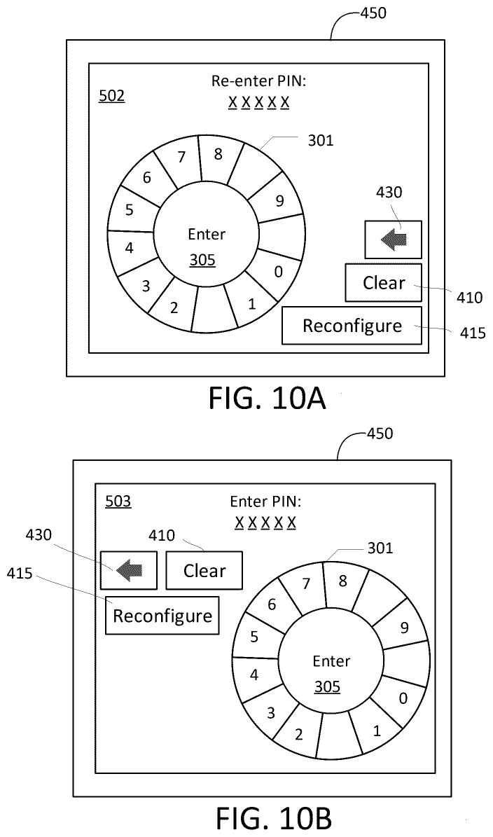

Also or alternatively, a reconfigured keypad may be moved to a different screen location. The reconfiguration may include shifts in the screen location of the circular configuration of keys and shifts in the screen location of other interface elements like the backspace, clear, and reconfigure buttons. Examples provided below in connection with FIGS. 10A-10B.

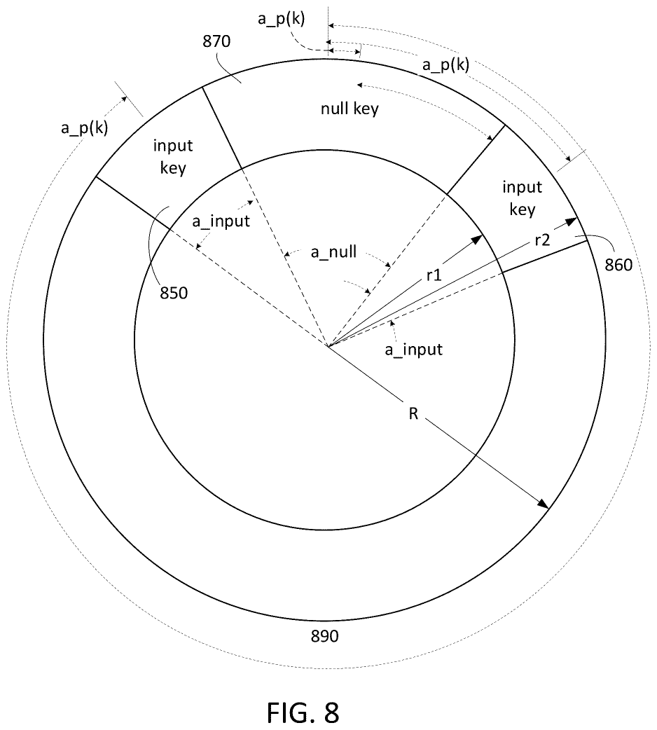

FIG. 8 shows examples of dimensions of a circular configuration of keys for a keypad. A circular configuration may have a radius R from a center of the keypad to an outer perimeter/circumference 890. Optionally, a circular configuration of a reconfigured keypad may be the same as a radius of a circular configuration of a keypad prior to reconfiguration (e.g., radius may remain constant during reconfiguration). Input keys (e.g., input keys 850 and 860 in FIG. 8) and null keys (e.g., null key 870 in FIG. 8) may comprise sectors of the circular configuration that have angular width a_input and a_null and that extend between an inner radius r1 and an outer radius r2. Radius r2 may, but need not be, the same as R. Input keys of a circular configuration may, but need not, have the same angular width a_input. Each null key of a circular configuration may, but need not, have a width a_null that is different from widths a_input of input keys in that circular configuration and/or that is different from widths a_null of other null keys in that circular configuration. Positions of input and null keys may be specified in any convenient manner. For example, a position of an input or null key may be defined by an angular displacement a_p(k) of a center of the key from a reference “Ref” (e.g., an angle corresponding to a 12 o'clock position), with “k” being an index of a particular input or null key.

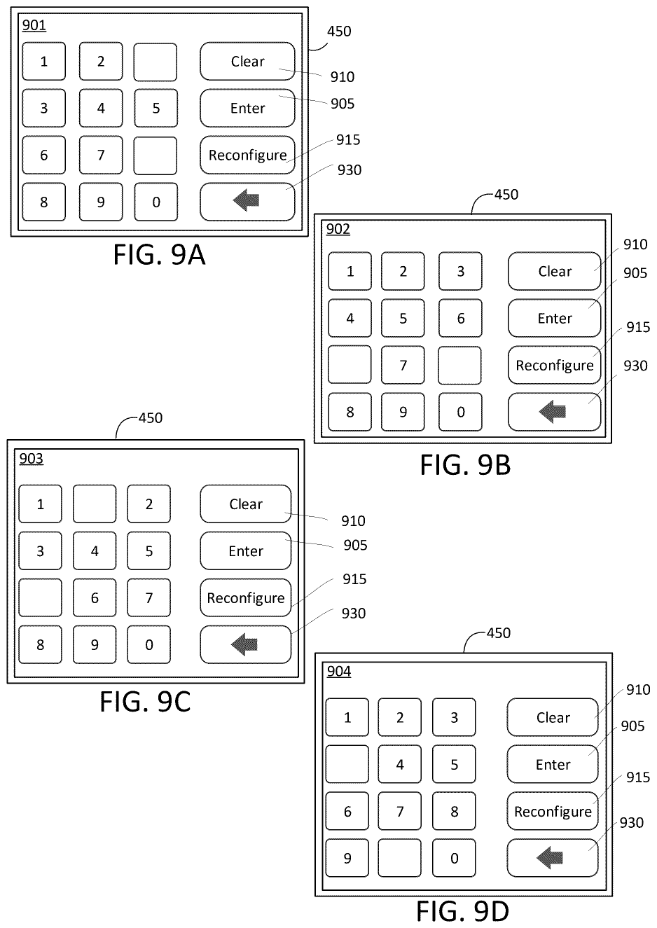

FIGS. 9A, 9B, 9C, and 9D show example user interfaces for receiving user input regarding authorization. The user interfaces of FIGS. 9A-4D may be output to the user of the display device 450. The user interfaces of FIGS. 9A-9D may comprise a keypad that comprises a plurality of input keys (e.g., rectangular input keys) and one or more null keys (e.g., one or more rectangular null keys) in a grid configuration, as well as an enter button 905 that may function similar to the enter button 305, a clear button 910 that may function similar to the clear button 410, a reconfigure button 915 that may function similar to the reconfigure button 415, and a backspace button 930 that may function similar to the backspace button 430. A computing device configured to cause output of interfaces comprising a circular configurations of keys may also or alternatively be configured to cause output of interfaces, such as the interfaces of FIGS. 9A-9D, that comprise grid configurations of keys. For example, a computing device may be configured to cause (e.g., in response to a request or other trigger for reconfiguration) output of an interface comprising a grid configuration of keys after having caused output of an interface comprising a circular configuration of keys, and/or vice versa.

As shown in FIG. 9A, the interface 901 may be output via the display device 450 to prompt the user for input of the code. The interface 901 may comprise a first rectangular grid configuration of rectangular regions, for example, comprising input keys and null keys. One or more of the input keys may be in a different rectangular region compared to one or more of the input keys of interfaces 902, 903, and/or 904. Interface 901 may have a first input key in a first position on the rectangular grid configuration. For example, interface 901 may have a input key “6” in the first position on the rectangular grid. The adjacent input keys of interface 902 with one or more null keys between them may be different as compared to one or more of the input keys of interface 902, 903, and/or 904. The input keys may be in ascending or descending order in one or more directions (e.g., left-to-right and top-to-bottom, right-to-left and bottom-to-top, etc.). By selecting one or more of the input keys, the user may provide input indicating their code for authorization.

As shown in FIG. 9B, the interface 902 may be output via the display device 450 to prompt the user for input of the code. The interface 902 may comprise a second rectangular grid configuration of rectangular regions, for example, comprising input keys and null keys. One or more of the input keys may be in a different rectangular region compared to one or more of the input keys of interfaces 901, 903, and/or 904. Interface 902 may have the first input key in a second position on the rectangular grid. For example, interface 902 may have the input key “6” in the second position on the rectangular grid. The adjacent input keys of interface 902 with one or more null keys between them may be different as compared to one or more of the input keys of interface 901, 903, and/or 904. By selecting one or more of the input keys, the user may provide input indicating the code for authorization.

As shown in FIG. 9C, the interface 903 may be output via the display device 450 to prompt the user for input of the code. The interface 903 may comprise a third rectangular grid configuration of rectangular regions, for example, comprising input keys and null keys. One or more of the input keys may be in a different rectangular region compared to one or more of the input keys of interfaces 901, 902, and/or 904. Interface 903 may have the first input key in a third position on the rectangular grid. For example, interface 903 may have the input key “6” in the third position on the rectangular grid. The adjacent input keys of interface 903 with one or more null keys between them may be different as compared to one or more of the input keys of interface 901, 902 and/or 904. By selecting one or more of the input keys, the user may provide input indicating their code for authorization.

As shown in FIG. 9D, the interface 904 may be output via the display device 450 to prompt the user for input of the code. The interface 904 may comprise a fourth rectangular grid configuration of rectangular regions, for example, comprising input keys and null keys. One or more of the input keys may be in a different rectangular region compared to one or more of the input keys of interfaces 901, 902, and/or 903. Interface 904 may have the first input key in a fourth position on the rectangular grid. For example, interface 904 may have the input key “6” in the fourth position on the rectangular grid. The adjacent input keys of interface 904 with one or more null keys between them may be different as compared to one or more of the input keys of interface 901, 902, and/or 903. By selecting one or more of the input keys, the user may provide input indicating their code for authorization.

FIGS. 10A-10B show an example sequence of a user entering or re-entering a code via a user interface output on a display device. The user interfaces of FIGS. 10A-10B may be output to the user of the display device 450. The functions of the enter button 305, reconfigure button 415, clear button 410, and backspace button 430 may be as previously described.

FIG. 10A shows the interface 501 may be output via display device 450 to prompt the user for re-entry of the code. The interface 501 may comprise a first circular configuration of sectors, for example, example circular configuration 301 comprising input keys and null keys. FIG. 10B shows an interface 503 may be output (e.g., after a request for, or other trigger of, reconfiguration) via display device 450 to prompt the user for entry of the code. The interface 503 may comprise the first circular configuration of sectors, for example, example circular configuration 301 comprising input keys and null keys. Also or alternatively, the screen location of the keypad and other interface elements (e.g., backspace button, clear button, reconfigure button) may shift on the interface 503. A randomization function (e.g., a random number generator, an algorithm or service that produces a random or pseudo-random number, for example, based on a seed) may determine the new screen location for the keypad within the interface. The randomization function may determine new positions for one or more interface elements, such as the backspace button 430, clear button 410, and reconfigure button 415. For example, in FIG. 10A, the keypad may be on the left side of the interface 501. In FIG. 10B, the keypad may be on the right side of the interface 503.

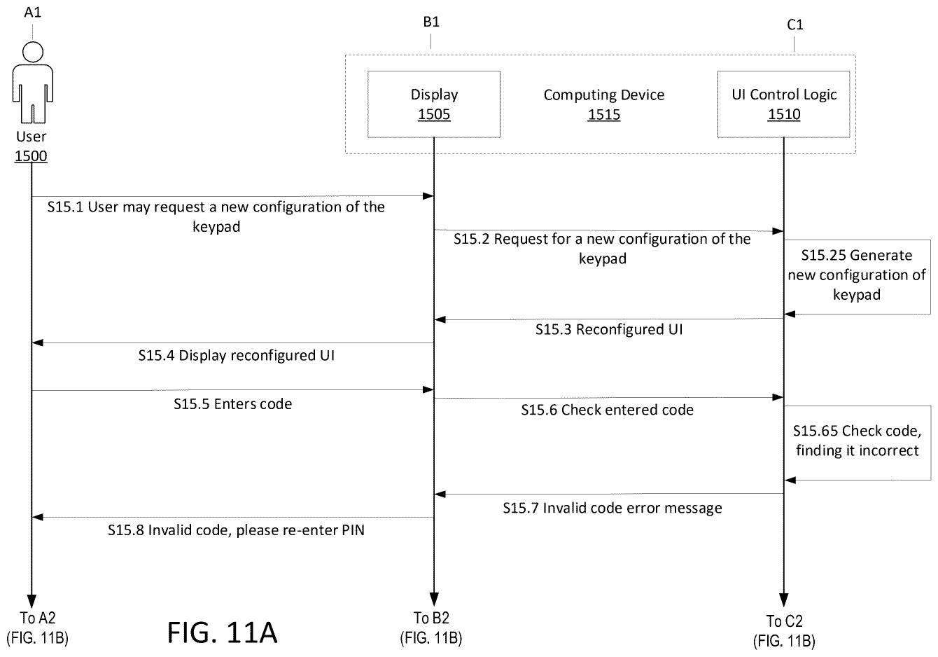

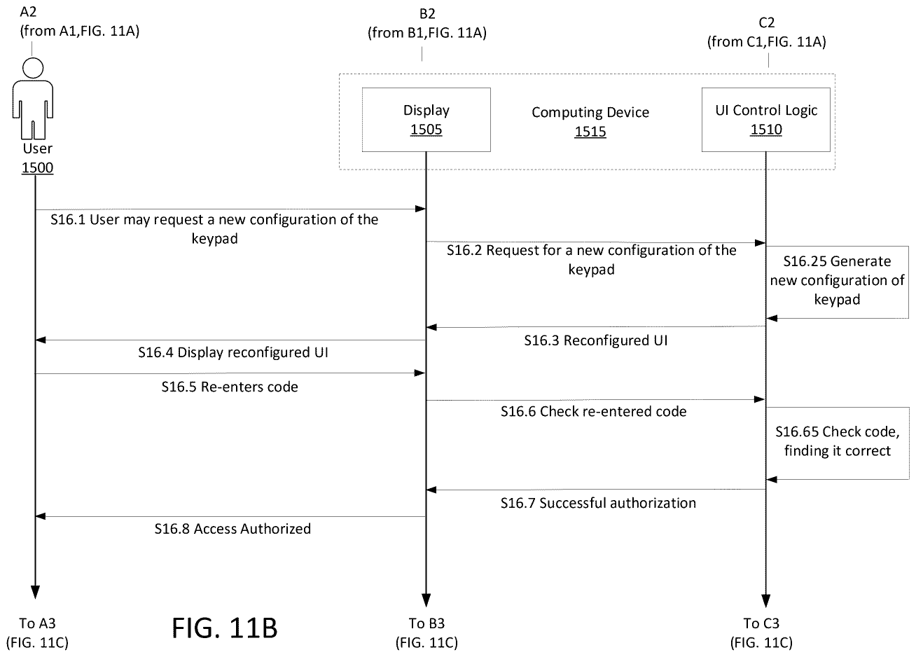

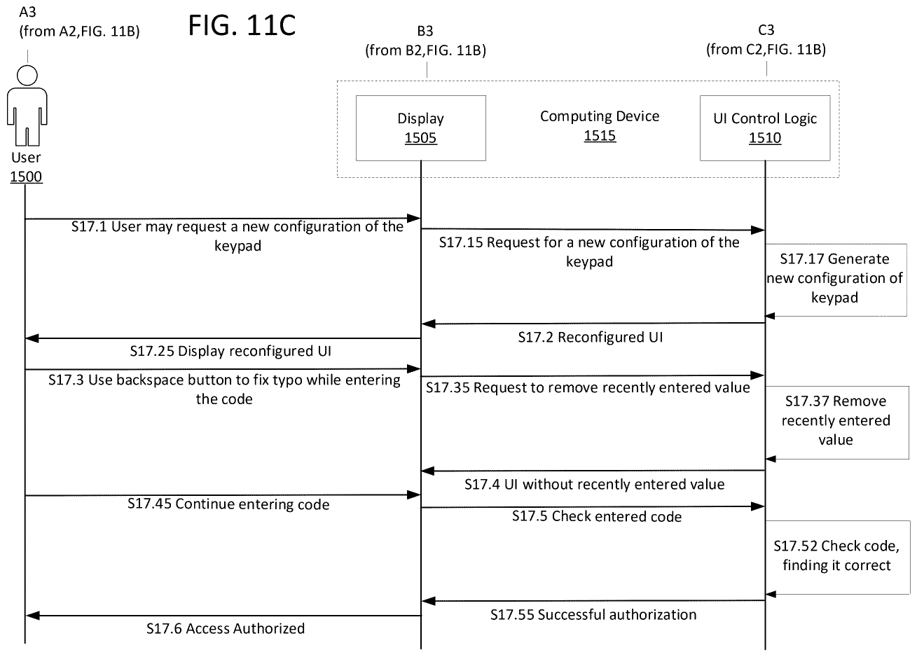

FIGS. 11A-11C are a sequence diagram showing an example workflow of example methods for receiving code inputs via a display 1505 to verify a user 1500. The display 1505 may be the display 405 and/or another display, and may be part of a computing device 1515 that comprises UI control logic 1510. The UI control logic 1510 may comprise one or more software applications or other processes executing on processors(s) of the computing device 1515, based on instructions stored in the memory of the computing device 1515, to perform operations described herein. Computing device 1515 may comprise one or more of the devices in premises 102a, for example, the ATM 118, personal computer 114, laptop computer 115, etc. Also or alternatively, some or all operations described for the UI control logic 1510 could be performed by a second computing device (e.g., reception server 122), with the display 1505 (e.g., a computing device comprising the display 1505) communicating with that second computing device via one or more networks. The actions in FIG. 11A-11C may be performed in different orders and with different, fewer, or additional actions. Multiple actions may be combined.

In step S15.1 (FIG. 11A) the user 1500 may request a new configuration of the keypad. For example, in FIG. 7A the user may request a new configuration of the keypad on interface 700 by selecting the reconfigure button 415. At step S15.2, the display 1505 may forward the reconfiguration request to the UI control logic 1510. The UI control logic 1510 may generate a new configuration of the keypad in step S15.25. The new configuration of the keypad may be one or more of any of the reconfiguration types previously described (e.g., rotationally shifted, different rotational order, different quantity of null keys, different size of null keys, change of position of keypad, change from circular configuration to grid configuration (or vice versa), etc.). In step 15.3, data comprising and/or indicating the reconfigured UI may be forwarded to the display 1505. In step S15.4, the reconfigured UI may be displayed to the user 1500 on the display 1505. At step S15.5, the user 1500 may enter the code via the reconfigured UI on the display 1505. The display 1505 may forward the code to the UI control logic 1510 at step S15.6 to be checked. The UI control logic 1510 may check the code and find it incorrect at step S15.65. The UI control logic 1510 may send an error message to the display 1505 at step S15.7. For example, in FIG. 6A, interface 601 may display an error message after the code is checked and found to be incorrect. In step S15.8, the display 1505 may display the error message to the user 1500 and request re-entry of the code. The error message may also display the number of attempts remaining before the interface is locked from future attempts.

FIG. 11B continues the example workflow at step S16.1, where the user 1500 may request a new configuration of the keypad. At step S16.2 the display 1505 may forward the request to the UI control logic 1510. The UI control logic 1510 may generate a reconfigured keypad in step S 16.25. In step 16.3, data comprising and/or indicating a reconfigured UI comprising the reconfigured keypad may be forwarded to the display 1505. In step S16.4, the reconfigured UI may be displayed to the user 1500 on the display 1505. At step S16.5, the user 1500 may re-enter the code via the reconfigured UI on the display 1505. For example, in FIG. 5B the interface 501 may prompt the user to re-enter the code after an incorrect attempt. The display 1505 may forward the re-entered code to the UI control logic 1510 at step S16.6 to be checked. The UI control logic 1510 may check the code and find it correct at step S16.65. The UI control logic 1510 may send a message indicating successful authorization to the display 1505 at step S16.7. In step S16.8, the display 1505 may display the successful authorization message to the user 1500. For example, in FIG. 5D the interface 404 may display a message that access is granted after a correct code is checked.

FIG. 11C continues the example workflow at step S17.1, where the user 1500 may request a new configuration of the keypad. The example workflow continues at step S17.15, where the display 1505 may forward the request to the UI control logic 1510. The UI control logic 1510 may generate a reconfigured keypad in step S 17.17. In step 17.2, data comprising and/or indicating a reconfigured UI comprising the reconfigured keypad may be forwarded to the display 1505. In step S17.25, the reconfigured UI may be displayed to the user 1500 on the display 1505. At step S17.3, the user 1500 may use the backspace button 430 to remove a recently entered value while entering the code. For example, in FIG. 4D the interface 402 may show the backspace button 430 that may be selected after a code is entered using example circular configuration 301. The display 1505 may forward the request to remove the recently entered value to the UI control logic 1510 at step S17.35. The UI control logic 1510 of the display device 450 may remove the recently entered value at step S17.37. The UI control logic 1510 may send data comprising and/or indicating the UI without the recently entered value to be reflected on the display 1505 at step S17.4. In step S17.45, the user 1500 may continue entering the code on the display 1505. In step S17.5, the display 1505 may forward the code to the UI control logic 1510 to be checked. For example, in FIG. 4D the interface 402 may show the enter button 305 that may be selected after a code is entered. The enter button 305 may initiate the request for the code to be checked. The UI control logic 1510 of the display device 450 may check the code and find it correct at step S17.52. The UI control logic 1510 may send a message indicating successful authorization to the display 1505 at step S17.55. In step S17.6, the display 1505 may display a message to the user 1500 that access is authorized.

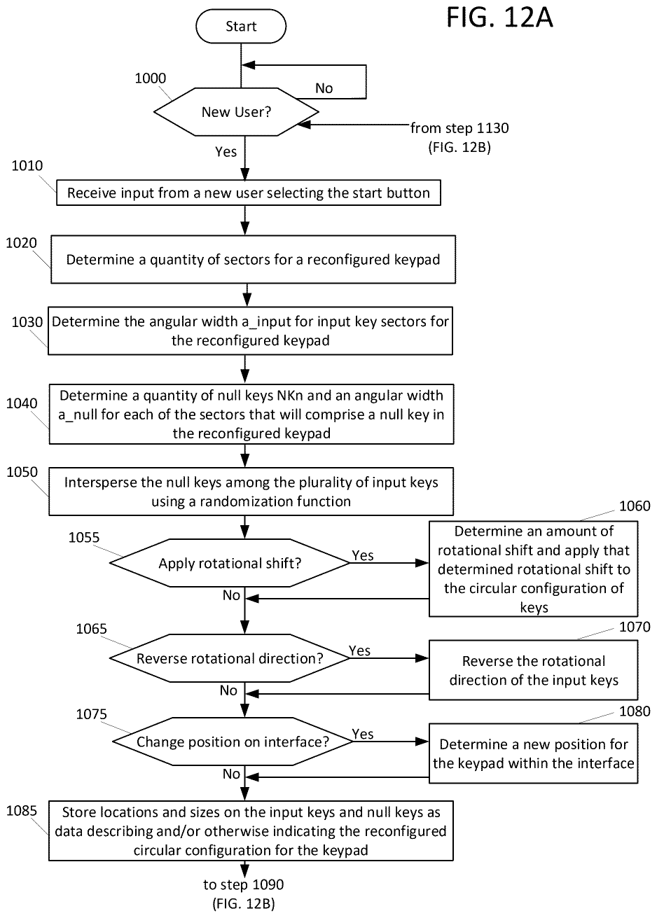

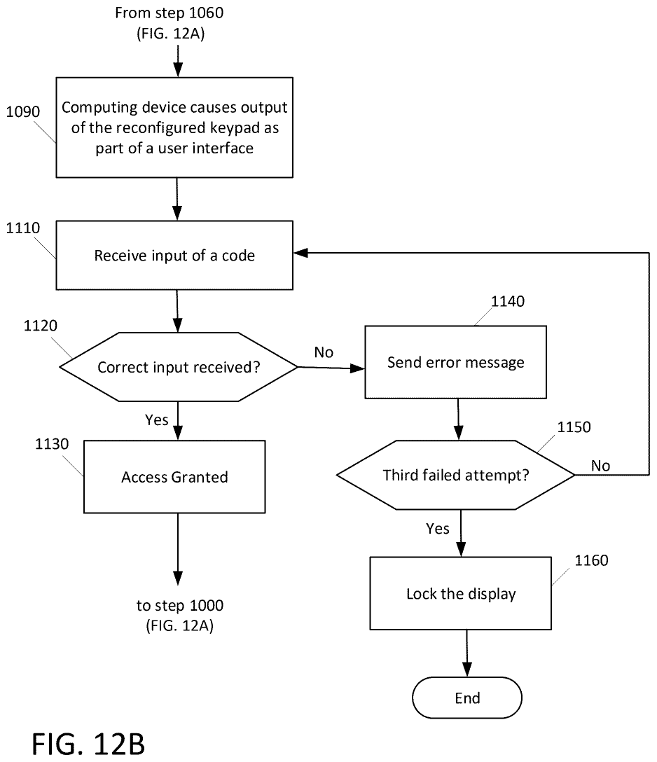

FIGS. 12A and 12B are a flow chart showing an example method for reconfiguring a circular configuration of sectors. The example method may be performed by one or more computing devices. For example, the method of FIGS. 12A-12B may be performed by the computing device 1515 of FIGS. 11A-11C, and for convenience, the method of FIGS. 12A-12B will be described by example of computing device 1515 performing the method. Also or alternatively, operations described in connection with FIGS. 12A-12B may be performed by separate computing devices. For example, one or more of the operations described in connection with FIGS. 12A-12B may be performed by a first computing device that comprises a display on which a keypad is being output, and one or more other operations described in connection with FIGS. 12A-12B may be performed by a second computing device (e.g., the reception server 122). Steps of the method of FIGS. 12A-12B may be performed in other orders, one or more steps may be omitted or modified, and/or other steps may be added.

In step 1000, the computing device 1515 may determine if a new user has approached the device. If yes, step 1010 may be performed. If no, step 1000 may be repeated.

In step 1010, the computing device 1515 may receive input from a new user selecting the start button by selecting a box associated with an option (e.g., by manipulating a remote control and pressing an enter key, by selecting with a mouse, by touching a touch-screen).

In step 1020, the computing device 1515 may determine a quantity of sectors for a reconfigured keypad. The computing device may, for example, determine the quantity of sectors by using a randomization function (e.g., a random number generator, an algorithm or service that produces a random or pseudo-random number, for example, based on a seed). The computing device 1515 may randomly (e.g., using a random number generator) determine the quantity of sectors between an upper and a lower bound. For example, the upper bound may be 20 and the lower bound may be 11. Each sector may contain a input key or a null key. The quantity of null keys may be determined by subtracting a known quantity of input keys (e.g., a quantity based on the quantity of members of a code element set) from the randomly determined quantity of sectors. For example, if 14 sectors are randomly generated and there are 10 input keys, then the quantity of null keys would be four.

In step 1030, the computing device 1515 may determine an angular width a_input° for input key sectors for the reconfigured keypad. The computing device may, for example, determine the angular width a_input° using a randomization function (e.g., a random number generator, an algorithm or service that produces a random or pseudo-random number, for example, based on a seed). The input keys may have the same angular widths. The computing device 1515 may randomly (e.g., using a random number generator) determine the angular widths of the input keys between an upper and lower bound. For example, the upper bound may be (360°−Min_null°)/NKi, with Min_null° being a minimum quantity of angular width reserved for null keys and NKi being a total quantity of input keys, and the lower bound may be a value (e.g., 15 degrees) corresponding to a minimum amount of screen space needed to display code element at a desired resolution. The sum of the angular widths of the input keys may be less than 360 degrees. The total of the angular widths of input keys may be 300 degrees, for example, if there are 10 input keys with an angular width of 30 degrees. The sum of the angular widths of the null keys (Total_null°) may be the remaining angular width of the circular configuration after the angular widths of the input keys are determined (e.g., Total_null°=Min_null°+(360°−NKi*a_input°)).

In step 1040, the computing device 1515 may determine a quantity of null keys (NKn) and an angular width a_null° for each of the of the sectors that will comprise a null key in the reconfigured keypad. Each of the null keys may have the same angular width. The quantity of null keys may be determined, for example, by determining the largest integer quantity of null keys (Max_NKn) that may be obtained from Total_null° if each null key has the same angular width and if each null key has at least a minimum angular width (Min_null°) (e.g., 5%), and by randomly selecting a value for NKn between 1 and Max_NKn. The angular width for each of the null keys may then be determined as Total_null°/NKn.

In step 1050, the computing device 1515 may intersperse the null keys among the plurality of input keys using a randomization function (e.g., a random number generator, an algorithm or service that produces a random or pseudo-random number, for example, based on a seed). The computing device 1515 may determine the total number of available positions within the keys. The computing device 1515 may, for each null key, identify the available positions between input keys (or between null and input keys, after a position for a first multiple null keys is assigned), use the randomization function to select one of the available positions, and assign the null key to that selected position. This process may repeat until all null keys are assigned to a position. One or more input keys may have one or more null keys between them. Also or alternatively, one or more adjacent input keys may not have null keys between them.

In step 1055, the computing device 1515 may determine whether a rotational shift may be applied to the circular configuration. If yes, step 1060 may be performed. If no, step 1065 may be performed.

In step 1060, the computing device 1515 may determine an amount of rotational shift and apply that determined rotational shift circular configuration of keys. The computing device 1515 may determine the amount of rotational shift by selecting (e.g., randomly) one of multiple predetermined values (e.g., one of 0°, 10°, 20°, 30°, . . . 350°). For example, FIGS. 3C and 3D show example circular configurations 302 and 303, respectively. As discussed previously, the circular configurations have the same rotational order but are rotationally shifted relative to the reference (e.g., the 12 o'clock position at top of circle).

In step 1065, the computing device 1515 may determine whether the rotational direction of the circular configuration may be reversed. If yes, step 1070 may be performed. If no, step 1075 may be performed. The computing device 1515 may make the determination of step 1065 by, for example, randomly selecting “yes” (e.g., change rotational direction) or “no” (e.g., do not change rotational direction).

In step 1070, the computing device 1515 may reverse the rotational direction of the input keys. For example, a circular configuration with input keys in following an ascending numerical order in a clockwise direction may be reconfigured so that same order is followed in a counterclockwise direction, or vice-versa. To reverse a rotational direction, the computing device 1515 may select (e.g., randomly) one of the input or null keys to maintain its position, and may move all of the other keys so as to achieve reconfiguration in the reverse rotational direction.

In step 1075, the computing device 1515 may determine whether the position of the circular configuration within the interface may be changed. If yes, step 1080 may be performed. If no, step 1085 may be performed. The computing device 1515 may make the determination of step 1065 by, for example, randomly selecting “yes” (e.g., change rotational direction) or “no” (e.g., do not change rotational direction).

In step 1080, the computing device 1515 may determine a new position for the keypad within the interface. For example, as described in FIGS. 10A-10B, a randomization function may determine the location for the keypad within the interface. The randomization function may also or alternatively determine new positions for one or more interface elements, such as the backspace button 430, clear button 410, and reconfigure button 415.

In step 1085, the computing device 1515 may store, as data describing and/or otherwise indicating the reconfigured circular configuration for the keypad, data determined in steps 1020-1080 (e.g., locations and sizes of the input keys and null keys). The key order is circular, meaning that after the last sector, the sequence continues with the first sector. Steps 1020-1080 may comprise, or be comprise be, any of steps S15.25 (FIG. 11A), S16.25 (FIG. 11B), or S17.17 (FIG. 11C).

In step 1090 (FIG. 12B), the computing device 1515 may cause output of the reconfigured keypad as part of user interface on display 1505. Step 1090 may comprise, or may be comprised by, steps S15.3, S16.3, and S17.2 of FIGS. 11A-11C. The output of the reconfigured keypad on the interface may be based on receiving a request for an action associated with the code. The output of the reconfigured virtual interface on the interface may be based on receiving a request to reconfigure the first plurality of keys for a next input of the code.

In step 1110, the computing device 1515 may receive input of a code from the user. Step 1110 may comprise, or may be comprised by, steps S15.5, S16.5, and S17.45 of FIGS. 11A-11C. The user may, for example, input the code using the input keys, as described in connection with the examples of FIGS. 4D, 5C, and 6C. The device may not receive an input from the null keys. The user may accidentally input an incorrect key. The user may use the clear button 410 or the backspace button 430 while entering the code to correct any typographical errors made while inputting the code.

In step 1120, the computing device 1515 may determine if a correct code input was received from the user in step 1110. Step 1120 may comprise, or may be comprised by, steps S15.6, S15.65, S16.6, S16.65, S17.5, and S17.52 of FIGS. 11A-11C. Step 1120 may, for example, comprise comparing the input code with stored data that associates the correct code with the user. If the user entered the correct code, step 1130 may be performed. If the user entered an incorrect code, step 1140 may be performed.

In step 1130, the computing device 1515 may grant access (e.g., to an application, a device, an account, a service) after input of the correct code. Step 1130 may comprise, or may be comprised by, steps S16.8 and S17.55 of FIGS. 11A-11C. Step 1130 may grant access to a user's account or user entry to many applications, including ATMs, mobile devices 125, home and/or building door entry, safe deposit boxes, etc. After step 1130, step 1000 may be performed. For example, after the user is finished, the computing device 1515 may receive an indication of a next user to begin reconfiguring the keypad for output to the next user as part of a user interface.

In step 1140, the computing device 1515 may cause output, via the display 1505, of an error message. Step 1140 may comprise, or may be comprised by, steps S15.7 and S15.8 of FIG. 11A. For example, interface 500 or interface 601 may be displayed on the display device 1515.

In step 1150, the computing device 1515 may determine if the user has input three invalid codes. If yes, step 1160 may be performed. If no, steps 1110 and 1120 may be repeated and the user may re-enter the code to be checked.

In step 1160, the computing device 1515 may lock the display 1505 after three failed attempts to input the correct code. The device may prevent the user from making further attempts to input the code. For example, interface 602 may be displayed on the display device 1505.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
outputting, by a computing device on a display, a first circular configuration of software buttons that comprise an associated plurality of input keys and one or more null keys;
receiving indications of selection of a code comprising one or more of the plurality of input keys; and
outputting, on the display, a reconfigured circular configuration of software buttons that comprise the plurality of input keys and the one or more null keys, wherein at least one of the input keys is disposed in a different location and associated with a different software button as compared with the first circular configuration.

2. The method of claim 1, wherein each of the plurality of input keys is located in a separate sector of a plurality of sectors of the first circular configuration of software buttons and wherein each of the one or more null keys, of the first circular configuration of software buttons, is located in a separate sector of the plurality of sectors.

3. The method of claim 1, wherein each of the plurality of input keys is mapped to a corresponding code element, of a set of code elements, and is selectable to generate an input of its corresponding code element as a part of the code and wherein each null key, of the one or more null keys, is not selectable to generate an input of a part of the code.

4. The method of claim 3, wherein each code element, of the set of code elements, is a numeric digit different from other code elements of the set.

5. The method of claim 1, wherein a quantity of the null keys of the first circular configuration of software buttons is different from a quantity of the null keys of the reconfigured circular configuration of software buttons.

6. The method of claim 1, wherein a null key, of the one or more null keys of the first circular configuration of software buttons, is located in a sector, of the first circular configuration of software buttons, having a first angular width and wherein a null key, of the one or more null keys of the reconfigured circular configuration of software buttons, is located in a sector, of the reconfigured circular configuration of software buttons, having a second angular width that is different from the first angular width.

7. The method of claim 1, wherein the display comprises a touch screen.

8. The method of claim 1, wherein positions of at least a portion of the plurality of input keys in the reconfigured circular configuration of software buttons are rotationally shifted relative to positions of the at least a portion of the plurality of input keys in the first circular configuration of software buttons.

9. The method of claim 1, wherein the outputting the reconfigured circular configuration of software buttons is based on one or more of:
receiving a request for an action associated with an authorization code for the action;
a determination that the code was correctly input; or
receiving a request to reconfigure the first circular configuration of software buttons.

10. The method of claim 1, wherein the outputting the first circular configuration of software buttons comprises outputting an interface that comprises the first circular configuration of software buttons and one or more of:
an enter button located centrally within the first circular configuration of software buttons;
a clear button;
a button corresponding to a request for reconfiguration of the first circular configuration of software buttons; or
a backspace button.

11. The method of claim 1, wherein each of the plurality of input keys is mapped to a corresponding code element of a set of code elements, wherein the plurality of input keys are arranged in the first circular configuration of software buttons so that the corresponding code elements follow an order in a clockwise direction, and wherein the plurality of input keys are arranged in the reconfigured circular configuration of software buttons so that the corresponding code elements follow the order in a counterclockwise direction.

12. The method of claim 1, wherein the outputting the reconfigured circular configuration of software buttons comprises determining, using a random number generator, one or more of:
a quantity of the one or more null keys of the reconfigured circular configuration of software buttons; or
one or more locations of the one or more null keys of the reconfigured circular configuration of software buttons.

13. A method comprising:
outputting, by a computing device on a display, a first circular configuration of software buttons that comprise an associated plurality of input keys and one or more null keys;
receiving indications of selection of a code comprising one or more of the plurality of input keys; and
outputting, on the display, a reconfigured circular configuration of keys that comprise the plurality of input keys and the one or more null keys, wherein a quantity of the one or more null keys of the first circular configuration of software buttons is different from a quantity of the one or more null keys of the reconfigured circular configuration of software buttons.

14. The method of claim 13, wherein the outputting the reconfigured circular configuration of software buttons comprises determining, using a random number generator, one or more of:
a quantity of the one or more null keys of the reconfigured circular configuration of software buttons; or
one or more locations of the one or more null keys of the reconfigured circular configuration of software buttons.

15. The method of claim 12, wherein a null key, of the one or more null keys of the first circular configuration of software buttons, is located in a sector, of the first circular configuration of software buttons, having a first angular width and wherein a null key, of the one or more null keys of the reconfigured circular configuration of software buttons, is located in a sector, of the reconfigured circular configuration of software buttons, having a second angular width that is different from the first angular width.

16. The method of claim 12, wherein positions of at least a portion of the plurality of input keys in the reconfigured circular configuration of software buttons are rotationally shifted relative to positions of the at least a portion of the plurality of input keys in the first circular configuration of software buttons.

17. A one or more nontransitory computer-readable media storing instructions that, when executed, cause:
outputting, by a computing device on a display, a first circular configuration of software buttons that comprise an associated plurality of input keys and one or more null keys;
receiving indications of selection of a code comprising one or more of the plurality of input keys; and
outputting, on the display, a reconfigured circular configuration of software buttons that comprise the plurality of input keys and the one or more null keys, wherein at least one of the input keys is disposed in a different location and associated with a different software button as compared with the first circular configuration.

18. The one or more nontransitory computer-readable media of claim 17, wherein a quantity of the null keys of the first circular configuration of software buttons is different from a quantity of the null keys of the reconfigured circular configuration of software buttons.

19. The one or more nontransitory computer-readable media of claim 17, wherein a null key, of the one or more null keys of the first circular configuration of software buttons, is located in a sector, of the first circular configuration of software buttons, having a first angular width and wherein a null key, of the one or more null keys of the reconfigured circular configuration of software buttons, is located in a sector, of the reconfigured circular configuration of software buttons, having a second angular width that is different from the first angular width.

20. The one or more nontransitory computer-readable media of claim 17, wherein the instructions, when executed, cause the outputting the reconfigured circular configuration of software buttons by causing determining, using a random number generator, one or more of:
a quantity of the one or more null keys of the reconfigured circular configuration of software buttons; or
one or more locations of the one or more null keys of the reconfigured circular configuration of software buttons.
